(19) United States
(12) Patent Application Publication
(10) Pub. No.: US 2014/0196811 A1
(43) Pub. Date: Jul. 17, 2014

(54) METHOD AND APPARATUS FOR DISPENSING A BEVERAGE IN ACCORDANCE WITH A BARCODE SCANNED FROM A BEVERAGE CONTAINER

(71) Applicant: XEROX CORPORATION, Norwalk, CT (US)

(72) Inventors: ROBERTO RAMOS, III, East Rochester, NY (US); Eliud Robles Flores, Webster, NY (US)

(73) Assignee: Xerox Corporation, Norwalk, CT (US)

(21) Appl. No.: 13/743,067

(22) Filed: Jan. 16, 2013

(51) Int. Cl. B65B 1/04; B67D 7/74; B65B 31/00

(52) U.S. Cl. CPC G06F 17/40
USPC 141/2; 141/351; 141/94; 222/129.1

(57) ABSTRACT

A method, non-transitory computer readable medium, and apparatus for dispensing a beverage are disclosed. For example, the method receives an indication that a customer desires to dispense a beverage, scans a barcode associated with a beverage container being used by the customer, dispenses the beverage in accordance with information obtained from scanning the barcode and stores one or more dispensing details associated with the dispensing.

The present disclosure relates generally to controlling and personalizing dispensing of beverages and, more particularly, to a method and an apparatus for dispensing a beverage in accordance with a barcode scanned from a beverage container.

### BACKGROUND

Many fast food restaurants provide a cup when a beverage is ordered for a self-serve beverage dispensing machine. Typically, a customer may use the cup to self serve a beverage from a beverage dispensing machine and receive unlimited free refills. Typically, the fast food restaurants intend to allow the cup to be used for unlimited free refills for a single visit. However, some customers take advantage of the free refill policy and use the same cup on multiple different occasions or different days to avoid purchasing another beverage.

### SUMMARY

According to aspects illustrated herein, there are provided a method, a non-transitory computer readable medium, and an apparatus for dispensing a beverage. One disclosed feature of the embodiments is a method that receives an indication that a customer desires to dispense a beverage, scans a barcode associated with a beverage container being used by the customer, dispenses the beverage in accordance with information obtained from scanning the barcode and stores one or more dispensing details associated with the dispensing.

Another disclosed feature of the embodiments is a non-transitory computer-readable medium having stored thereon a plurality of instructions, the plurality of instructions including instructions which, when executed by a processor, cause the processor to perform a method that receives an indication that a customer desires to dispense a beverage, scans a barcode associated with a beverage container being used by the customer, dispenses the beverage in accordance with information obtained from scanning the barcode and stores one or more dispensing details associated with the dispensing.

Another disclosed feature of the embodiments is an apparatus comprising a processor that is configured to receive an indication that a customer desires to dispense a beverage, to scan a barcode associated with a beverage container being used by the customer, to dispense the beverage in accordance with information obtained from scanning the barcode and to store one or more dispensing details associated with the dispensing.

### BRIEF DESCRIPTION OF THE DRAWINGS

The teaching of the present disclosure can be readily understood by considering the following detailed description in conjunction with the accompanying drawings, in which:

FIG. 1 illustrates one example of a beverage dispensing system;

FIG. 2 illustrates an example of a beverage dispensing system having a display;

FIG. 3 illustrates an example flow chart of a method for dispensing a beverage; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium, and apparatus for dispensing a beverage. As discussed above, many fast food restaurants are trying to control abuse of the free refill policy at self serve beverage stations offered by many of the fast food restaurants.

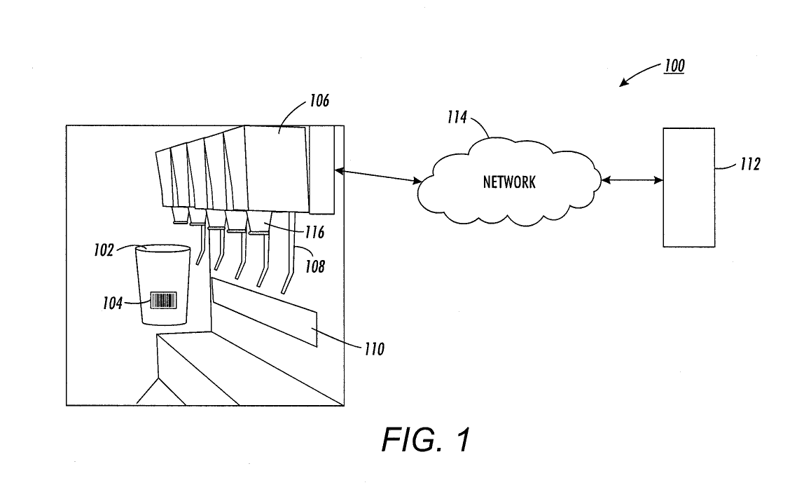

FIG. 1 illustrates one example of a beverage dispensing system 100. In one embodiment, the system 100 may include a beverage dispensing machine 106 in communication with a network 114 and a server 112. In one embodiment, the network 114 may be any type of communication network 114 to allow the beverage dispensing machine 106 and the server 112 to transmit information. For example, the network 114 may be a wired or wireless network. For example, the network 114 may be a Wireless Fidelity (Wi-Fi) network, a local area network (LAN), a wide area network (WAN), an access network, the Internet, a cellular network (e.g., 3G, 4G LTE, and the like), and the like.

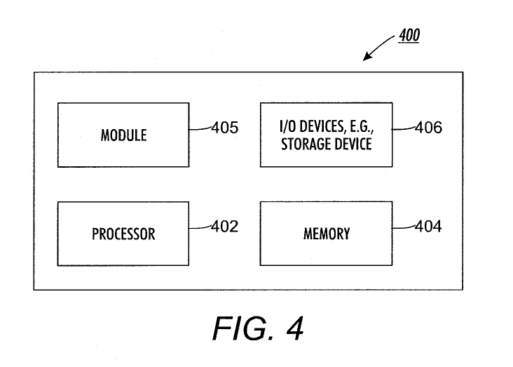

In one embodiment, the server 112 may be remotely located from the beverage dispensing machine 106. For example, the server 112 may be located in another building or a different physical or geographical location. The server 112 may also include a memory and serve as a database. In one embodiment, the server 112 may be embodied as a general purpose computer described below with reference to FIG. 4.

In one embodiment, the beverage dispensing machine 106 may include a dispensing nozzle 116, a dispensing handle 108 and a barcode reader 110. In one embodiment, the barcode reader 110 may read a barcode 104 located on a beverage container 102. In one embodiment, the beverage dispensing machine 106 may include a processor and a memory, for example, similar to the general purpose computer described below with reference to FIG. 4.

In one embodiment, the barcode reader 110 may automatically read the barcode 104 when a customer (broadly a user) attempts to dispense a beverage. For example, when a customer presses the beverage container 102 against the dispensing handle 108, the dispensing handle 108 may be configured to activate the barcode reader 110. The barcode 104 may be located on the beverage container 102 such that it aligns with the barcode reader 110 and can be read by the barcode reader 110 automatically without much manipulation of the beverage container 102 by the customer. For example, the barcode 104 may be located all around the beverage container 102 such that the barcode 104 may be read irrespective of the orientation of the beverage container 102 when pressed against the dispensing handle 108.

In one embodiment, the barcode 104 may include any type of barcode that provides a unique identifier, e.g., a universal product code (UPC) barcode, a quick response (QR) code, a one dimensional barcode, a two-dimensional barcode. In other words, no two barcodes may be the same.

Various types of information may be associated with the barcode 104. In one embodiment, when the barcode 104 is read by the barcode reader 110, the beverage dispensing machine 106 may record one or more dispensing details associated with the beverage that is dispensed and associate the one or more dispensing details with the barcode 104. For example, the one or more dispensing details may include a time the beverage was dispensed, a name of the beverage or beverages that were dispensed, an amount of the beverage that was dispensed, a location information (e.g., an address, Global Positioning System (GPS) coordinates, a store number, etc.), and the like.

In addition, the beverage dispensing machine 106 may track one or more dispensing details over a period of time (e.g., 12 hours, 24 hours, 1 week, 1 month, and the like). For example, the beverage dispensing machine 106 may track how many times a beverage has been dispensed into the beverage container 102 having the barcode 104, how much of each type of beverage that has been dispensed overall, a total amount of each type of beverage that has been dispensed for a particular barcode 104, a number of available refills, which geographic regions prefer which beverages, and the like.

As a result, this information may help to control abuse of a refill policy at a fast food restaurant. For example, if the policy for free refills is that the refill is only valid for a single visit, the fast food restaurant may set a reasonable time limit of 24 hours for free refills to be valid. As a result, when the barcode 104 is initially read for the first time, the beverage dispensing machine 106 may note the time the beverage was poured for a particular barcode 104. Within 24 hours of the initial dispensing, the customer may continue to obtain free refills from the beverage dispensing machine 106. However, after the 24 hours have expired, if the customer attempts to request a refill, the beverage dispensing machine 106 may determine that the time period for free refills has expired, assume that the customer is attempting to use the same beverage container 102 on a different day and deny the request to dispense a beverage.

In another embodiment, each barcode 104 may indicate a number of available refills. As result, each time the barcode 104 is read, the beverage dispensing machine 106 may record the unique identifier for the barcode 104 and the available number of refills. If the available number of refills is greater than zero, the beverage dispensing machine 106 may dispense the requested beverage and decrement the available number of refills by one until the available number of refills reaches zero.

In one embodiment, if the barcode reader 110 fails to read the barcode 104, the beverage dispensing machine 106 may be set to a default dispense state. As a result, if there is a barcode reading error, the beverage dispensing machine 106 would still dispense the requested beverage in one embodiment. Alternatively, in one embodiment, the beverage dispensing machine 106 may display a message to inform the customer to request a new beverage container due to a reading error.

In one embodiment, the information contained in the barcode 104 may also include personal information. In one embodiment, the personal information may be obtained automatically from an electronic transaction. For example, most electronic transactions are paid for with a credit card, a debit card, a cash card, a mobile endpoint device, and the like. The credit card may be linked to personal information of the customer such as name, address, demographic information, birth date, and the like. As a result, when the credit card is processed, personal information of the customer may be obtained and printed in a barcode.

In one embodiment, the barcode may be printed on an adhesive barcode label that may be attached around the beverage container 102. For example, the beverage container 102 may include a marking to where the adhesive barcode label should be placed such that it is aligned with the barcode reader 110 of the beverage dispensing machine 106.

In another embodiment, the barcode may simply be printed on the receipt. The beverage container 102 may be made with a pre-existing barcode 104. The barcode 104 of the beverage container 102 may be scanned and the barcode on the receipt may be scanned to link the personal information to the barcode 104 on the beverage container 102.

In another embodiment, the information may be obtained by requesting the customer to pre-populate information to obtain a personal barcode that could be mailed to the customer and applied to a personal beverage container. For example, the barcode 104 may be an adhesive backed label that is mailed to the customer in advance after his or her personal information is submitted and the beverage container 102 may be a personal reusable beverage container.

In one embodiment, the personal information may be obtained via a web interface. For example, a coffee house may have a website where customers may go and provide personal information including name, address, beverage preferences (e.g., a particular drink, a particular way they like to have their beverage prepared), link a personal calendar, upload personal photographs, and the like. In one embodiment, the fast food restaurant or beverage vendor may offer a coupon or discount to encourage customers to register information for the personalized barcode. In another embodiment, the personal information may be obtained by obtaining permission from the customer to link to a social networking account (e.g., Facebook® or Twitter®) that already contains the customer's personal information and preferences.

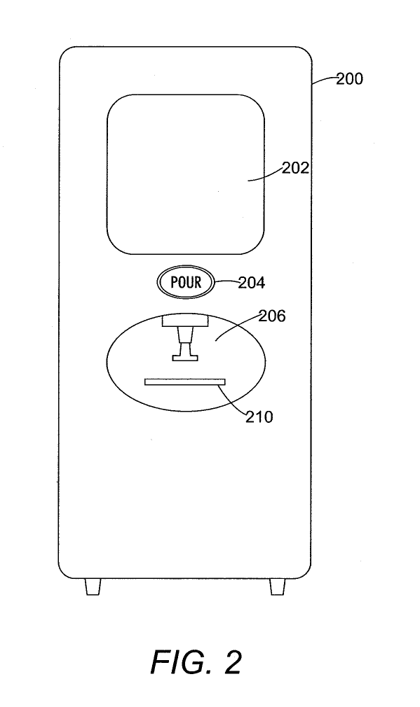

As a result, when the barcode reader 110 of the beverage dispensing machine 106 reads a barcode 104 that contains personal information, the customer experience may be personalized. For example, beverage dispensing machines are becoming more sophisticated as shown in FIG. 2. FIG. 2 illustrates a beverage dispensing machine 200 having a touch screen display 202. The beverage dispensing machine 200 may also include a pour button 204, a dispensing handle 206 and a barcode reader 210.

In one embodiment, the beverage dispensing machine 200 may include a processor and memory (not shown) similar to the general purpose computer described below with reference to FIG. 4. The beverage dispensing machine 200 may also be in communication with a network 114 and a server 112 similar to the beverage dispensing machine 106 illustrated in FIG. 1.

In one embodiment, when the personal information from the barcode 104 is scanned by the barcode reader 210, the display 202 may provide personal information. For example, the display 202 may greet the customer and display his or her name and a greeting. If the customer uploaded a photograph, the display 202 may display the photograph in the background.

In one embodiment, if the beverage dispensing machine 200 were located in an office environment and if the customer linked a calendar, the display 202 may show scheduled appointments or reminders for the day. As a result, the customer may be reminded of daily appointments and tasks as he or she obtains his or her morning beverage.

In addition, the beverage dispensing machine 200 may be capable of mixing a variety of ingredients or different types of beverages simultaneously. As a result, if the personal information contains the customer's beverage preferences, the beverage dispensing machine 200 may automatically dispense the beverage in accordance with the customer's beverage preferences. For example, the customer's beverage preference may be for a beverage having a mixture of soda A and soda B, soda A having more syrup, a coffee with 2 creamer cubes and 1 sugar cube, and the like.

In one embodiment, each time the barcode 104 is read, the one or more dispensing details may be recorded and associated with the personal information included in the barcode 104. As a result, the information may reveal how a particular customer's beverage preferences change over time, how much of each type of beverage he or she consumes over a predefined time period (e.g., each day, a week, a month, a year, and the like), and the like.

In one embodiment, the one or more dispensing details and other personal information recorded by the beverage dispensing machine 106 or 200 may be transmitted over the network 114 to the server 112. In one embodiment, the transmission may be performed periodically (e.g., once a day, once a week, once a month, and the like). In one embodiment, the amount of memory in the beverage dispensing machine 106 and 200 may be limited. As a result, the burden of storage and analysis of information may be transferred to the server 112 by transmitting the one or more dispensing details and/or other personal information to the server 112.

In addition, the one or more dispensing details and associated personal information may be valuable to the fast food restaurants, beverage houses, beverage vendors and beverage companies. For example, the fast food restaurants and beverage houses may be able to track which beverages are the most popular and which are the least popular and adjust their inventory accordingly. In addition, they may track which beverages are most popular during peak lunch periods or dinner periods and be prepared to quickly replenish those beverages more quickly in the beverage dispensing machines 106 and 200 during these peak periods.

The fast food restaurants and beverage houses may be able to sell this information to the beverage companies. The beverage companies may want to pay for this information for similar inventory reasons and also to provide targeted advertising to particular customers who tend to consume more of their beverages.

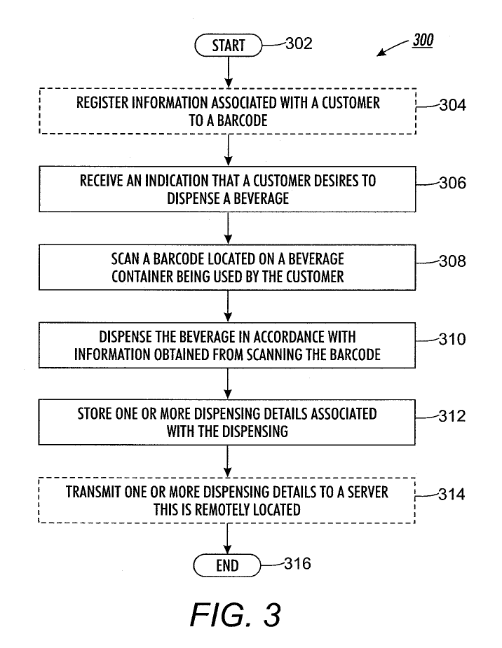

FIG. 3 illustrates a flowchart of a method 300 for dispensing a beverage. In one embodiment, the method 300 may be performed by the beverage dispensing machine 106 or 200 or a general-purpose computer as illustrated in FIG. 4 and discussed below.

The method 300 begins at step 302. The method 300 may begin by performing optional step 304. At optional step 304, the method 300 registers information associated with a customer to a barcode. For example, the customer may provide personal information via a website of the fast food restaurant or beverage house or link information from a social network website that they already have an account with. The personal information may then be associated with a barcode that can be mailed to the customer (or printed locally by the customer) and applied to a re-usable personal beverage container.

At step 306, the method 300 receives an indication that a customer desires to dispense a beverage. For example, the indication may be when the customer presses his or her beverage container against a dispensing handle of the beverage dispensing machine. When the dispensing handle is “clicked” (e.g., via a mechanical or electrical switch), this may send an indication to the beverage dispensing machine that the customer desires to dispense a beverage. In one embodiment, the indication may simply be a button on more sophisticated beverage dispensing machines, e.g., a “pour” button.

At step 308, the method 300 scans a barcode associated with a beverage container being used by the customer. In one embodiment, the barcode may be associated with the beverage container by being located on the beverage container. In another embodiment, the barcode may be associated with the beverage container by being located on a receipt of the purchased beverage container. For example, when the dispensing handle is “clicked” (broadly activated or engaged), this may also activate a barcode scanner (e.g., via an electrical signal) on the beverage dispensing machine to automatically read the barcode on the beverage container.

At step 310, the method 300 dispenses the beverage in accordance with the information obtained from scanning the barcode. For example, the barcode may track how many refills are available or a time range when refills are available for the beverage container. As a result, if a refill is available, the beverage dispensing machine may dispense the beverage.

In one embodiment, the information scanned from the barcode may include personal information. The personal information may include a beverage preference of the customer, a calendar of events (broadly a schedule) associated with the customer or a picture. In one embodiment, the beverage preference of the customer may include a ranked list of beverages the customer prefers, how the customer likes to have his or her beverage prepared, and the like.

As a result, if the beverage dispensing machine is a more sophisticated machine with a display, the beverage dispensing machine may display a greeting with the customer's name, may display a personalized message, e.g., “happy birthday!” if it is the customer's birthday, a personal picture selected by the customer, a calendar or appointment reminder, and the like.

In one embodiment, the beverage may be dispensed in accordance with the beverage preferences of the customer. For example, the customer may have a beverage preference in order of diet soda, zero calorie soda, lemon lime soda, and so forth. So the beverage dispensing machine may automatically dispense the highest ranked beverage preference of the customer that is available. In another embodiment, the beverage preference may indicate the customer likes to mix lemonade with an iced tea, so the beverage preference may automatically dispense a mixture of lemonade and iced tea. In another embodiment, the customer may prefer two sugar cubes and one creamer cube for coffee. As a result, if the customer selects a coffee beverage, the beverage dispensing machine may automatically add two sugar cubes (e.g., an amount of sugar formed into a cube, a tablet and the like) and one creamer cube (e.g., an amount of artificial creamer formed into a cube, a tablet and the like) for the customer. Other examples may be apparent and the above are only provided as examples and should not be considered limiting.

In one embodiment, the personal information may be obtained automatically, for example, from a credit card transaction. In another embodiment, the personal information may be obtained from the customer directly via the registration step described in the optional step 304.

At step 312, the method 300 stores one or more dispensing details associated with the dispensing. For example, the one or more dispensing details may include a time the beverage was dispensed, a name of the beverage or beverages that were dispensed, an amount of the beverage that was dispensed, a location information (e.g., an address, GPS coordinates, a store number, etc.), and the like.

In addition, the beverage dispensing machine 106 may track one or more dispensing details over a period of time (e.g., 12 hours, 24 hours, 1 week, 1 month, and the like). For example, the beverage dispensing machine 106 may track how many times a beverage has been dispensed into the beverage container 102 having the barcode 104, how much of each type of beverage that has been dispensed overall, a total amount of each type of beverage that has been dispensed for a particular barcode 104, a number of available refills, which geographic regions prefer which beverages, and the like.

In one embodiment, each time the barcode 104 is read, the one or more dispensing details may be recorded and associated with the personal information included in the barcode 104. As a result, the information may reveal how a particular customer's beverage preferences change over time, how much of each type of beverage he or she consumes over a predefined time period (e.g., each day, a week, a month, a year, and the like), and the like.

The method 300 may then perform optional step 314. At optional step 314, the method 300 may transmit the one or more dispensing details to a server that is remotely located from the beverage dispensing machine. For example, the one or more dispensing details and other personal information recorded by the beverage dispensing machine may be transmitted over a network to the server. In one embodiment, the transmission may be performed periodically (e.g., once a day, once a week, once a month, and the like). In one embodiment, the amount of memory in the beverage dispensing machine may be limited. As a result, the burden of storage and analysis of information may be transferred to the server by transmitting the one or more dispensing details and/or other personal information to the server.

In addition, the one or more dispensing details and associated personal information may be valuable to the fast food restaurants, beverage houses, and beverage companies. For example, the fast food restaurants and beverage houses may be able to track which beverages are the most popular and which are the least popular and adjust their inventory accordingly. In addition, they may track which beverages are most popular during peak lunch periods, dinner periods, time of year (e.g., spring, summer, fall, winter or a particular month) and be prepared to quickly replenish those beverages more quickly in the beverage dispensing machine during these peak periods.

The fast food restaurants and beverage houses may be able to sell this information to the beverage companies. The beverage companies may want to pay for this information for similar inventory reasons and also to provide targeted advertising to particular customers who tend to consume more of their beverages. The method 300 ends at step 316.

It should be noted that although not explicitly specified, one or more steps or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, blocks or operations in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises a hardware processor element 402 (e.g., a microprocessor, a central processing unit (CPU) and the like), a memory 404, e.g., random access memory (RAM) and/or read only memory (ROM), a module 405 for dispensing a beverage, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps, functions, or operations of the above disclosed methods. In one embodiment, the present module or process 405 for dispensing a beverage can be loaded into memory 404 and executed by processor 402 to implement the functions as discussed above. As such, the present method 405 for dispensing a beverage (including associated data structures) of the present disclosure can be stored on a non-transitory (e.g., physical and tangible) computer readable storage medium, e.g., RAM memory, magnetic or optical drive or diskette and the like. For example, the hardware processor 402 can be programmed or configured with instructions (e.g., computer readable instructions) to perform the steps or operations of method 300.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for dispensing a beverage, comprising:
receiving an indication that a customer desires to dispense a beverage;
scanning a barcode associated with a beverage container being used by the customer;
dispensing the beverage in accordance with information obtained from scanning the barcode; and
storing one or more dispensing details associated with the dispensing.

2. The method of claim 1, wherein the scanning is performed by a beverage dispensing machine when a dispensing handle is activated.

3. The method of claim 1, further comprising:
transmitting the one or more dispensing details to a server that is remotely located.

4. The method of claim 1, wherein the one or more dispensing details comprise at least one of: a type of beverage that was dispensed, an amount of the beverage that was dispensed, location information or a time that the beverage was dispensed.

5. The method of claim 1, wherein the information obtained from scanning the barcode comprises at least one of: a number of available refills or a valid time period for obtaining a refill.

6. The method of claim 1, wherein the information obtained from scanning the barcode comprises personal information associated with the customer.

7. The method of claim 6, wherein the personal information is obtained via a website.

8. The method of claim 6, wherein the personal information is obtained from an electronic transaction.

9. The method of claim 6, wherein the personal information comprises at least one of: a beverage preference of the customer, a schedule of events associated with the customer, or a picture.

10. A non-transitory computer-readable medium having stored thereon a plurality of instructions, the plurality of instructions including instructions which, when executed by a processor, cause the processor to perform operations for dispensing a beverage, the operations comprising:
receiving an indication that a customer desires to dispense a beverage;
scanning a barcode associated with a beverage container being used by the customer;
dispensing the beverage in accordance with information obtained from scanning the barcode; and
storing one or more dispensing details associated with the dispensing.

11. The non-transitory computer-readable medium of claim 10, wherein the scanning is performed by a beverage dispensing machine when a dispensing handle is activated.

12. The non-transitory computer-readable medium of claim 10, further comprising:
transmitting the one or more dispensing details to a server that is remotely located.

13. The non-transitory computer-readable medium of claim 10, wherein the one or more dispensing detail comprise at least one of: a type of beverage that was dispensed, an amount of the beverage that was dispensed, location information or a time that the beverage was dispensed.

14. The non-transitory computer-readable medium of claim 10, wherein the information obtained from scanning the barcode comprises at least one of: a number of available refills or a valid time period for obtaining a refill.

15. The non-transitory computer-readable medium of claim 10, wherein the information obtained from scanning the barcode comprises personal information associated with the customer.

16. The non-transitory computer-readable medium of claim 15, wherein the personal information is obtained via a website.

17. The non-transitory computer-readable medium of claim 15, wherein the personal information is obtained from an electronic transaction.

18. The non-transitory computer-readable medium of claim 15, wherein the personal information comprises at least one of: a beverage preference of the customer, a schedule of events associated with the customer, or a picture.

19. A method for dispensing a beverage, comprising:
receiving an indication that a customer desires to dispense a beverage into a beverage container associated with a barcode, wherein the barcode contains personal information associated with the customer that was pre-registered by the customer;
scanning the barcode associated with a beverage container being used by the customer;
dispensing the beverage in accordance with the personal information obtained from scanning the barcode;
storing dispensing one or more details associated with the dispensing, wherein the one or more dispensing details comprise a type of beverage that was dispensed, an amount of the beverage that was dispensed, a time that the beverage was dispensed and the personal information; and
transmitting the one or more dispensing details to a server and tracking the one or more dispensing details over a period of time.

20. The method of claim 19, wherein the personal information comprises at least one of: a beverage preference of the customer, a schedule of events associated with the customer, or a picture.
